(19) United States
(12) Patent Application Publication
(10) Pub. No.: US 2001/0008118 A1
(43) Pub. Date: Jul. 19, 2001

(54) Coating machine for direct or indirect coating of a material web

(76) Inventors: Richard Bernert, Giengen (DE); Manfred Ueberschs, Gerstetten (DE); Eckhard Wozny, Heidenheim (DE); Dennis Fartheymuller, Heidenheim (DE)

Correspondence Address: Todd T. Taylor, TAYLOR & AUST, P.C., 142 S. Main St., P.O. Box 560, Avilla, IN, 46710, US

(21) Appl. No.: 09/759,313

(22) Filed: Jan. 12, 2001

(30) Foreign Application Priority Data
Jan. 14, 2000 (DE) 100 01 392.9

(51) Int. Cl. B05C 11/02

(52) U.S. Cl. 118/123

(57) ABSTRACT

A coating machine for directly or indirectly applying a coating to a material web is designed to apply liquid or viscid coating medium onto a moving surface. The coating machine includes a discharge nozzle for discharging a coating medium onto the moving surface. The discharge nozzle has a first nozzle lip residing on the feed-side, and a second nozzle lip residing on the trailing side with respect to the moving surface. At least one of the first and second nozzle lips is composed of a blade element.

### BACKGROUND OF THE INVENTION

1. Field of the Invention

This invention relates to a machine designed for direct or indirect application of a liquid or viscid coating medium onto a moving surface; whereby, in the case of direct application, the moving surface is the outer surface of a material web such as paper or cardboard, or, in the case of indirect application, the moving surface is the outer surface of a transfer element, preferably a transfer roll capable of transferring coating medium onto the material web; and whereby the coating machine includes a discharge nozzle for the purpose of discharging coating medium onto the surface with nozzle lips that reside on the feed-side and trailing side with respect to the moving surface.

2. Description of the Related Art

Generic free-jet nozzle coating machines are known from documents DE 44 32 177 A1, EP 0 846 804 A1 and U.S. Pat. No. 5,603,767. These documents describe designs in which one of the nozzle lips is mounted rigidly, the other nozzle lip being adjustable for the purpose of varying the height of the nozzle gap. None of the disclosed free-jet nozzle coating machines allow the adjustment of the nozzle gap to occur quickly and temporarily or allow the opening thereof in such a manner to “blow out” contaminants which tend to lower the quality of the coating.

### SUMMARY OF THE INVENTION

The present invention relates to a coating machine of the type mentioned above which provides an improved mechanism to adjust the height of the nozzle gap.

The invention comprises, in one form thereof, a coating machine of the type mentioned above, the machine including nozzle lips of which at least one of them being formed by a blade element. By applying an elastic nozzle lip, the nozzle gap can be quickly and temporarily enlarged so that the pressure of the coating medium being supplied to the nozzle gap temporarily increases. Such a pressure pulse not only widens the nozzle gap as a result of any deflection of the blade element but also loosens any contaminants and literally blows them out of the nozzle gap. After the pressure pulse has subsided, the blade element reverts to its original position and the nozzle gap reliably changes to its original height. The blade element is preferably manufactured from steel. It is also possible to use blade elements made of fiber-reinforced plastic and, in particular, blade elements made of carbon fiber-reinforced plastic (CFRP), glass fiber-reinforced plastic (GFK), or a similar material.

In a further embodiment of this invention, the coating machine incorporates a mechanism for adjusting the height of the nozzle gap. Such a mechanism permits a variation of the coating medium being applied onto the moving surface by the coating machine with respect to a unit time.

In accordance to a first embodiment, the adjusting mechanism acts upon the blade element. In accordance to a first adjustment device of this first embodiment, the blade element can be deformed or pivoted by an adjusting unit of the adjusting mechanism. More specifically, the height of the nozzle gap can either be increased or decreased by a corresponding activation of the adjusting mechanism, starting from an initial base position of the blade element which is unaffected by the adjusting mechanism.

From a design perspective, the case of increasing the height can be accomplished by holding the blade element with one of its own length-wise edges (positioned in a transverse direction) against the coating machine, the blade element being further supported at the coating machine at a position between its two length-wise edges, and by allowing the adjusting unit to act upon the blade element at a position that is located between the support position and the mounting edge, extending in a length-wise direction.

Increasing the height can be accomplished by holding one of the blade element's own length-wise edge (positioned in a transverse direction) against the coating machine and by allowing the adjusting unit to act upon the blade element, causing it to bend at a position that is located between the length-wise mounting edge and the free length-wise edge. Alternatively, the blade element can also be mounted via a pivot bearing. The adjusting mechanism can then pivot the blade element against an opposing spring force. Alternatively, the adjusting mechanism may include two partial adjusting mechanisms that act upon the blade element in opposite directions.

If there is a preferred operating height of the nozzle gap, a mechanical stop can be provided which defines a condition of maximum deflection or pivoting movement of the blade element corresponding to the desired operating gap height. In this condition, the gap height is essentially independent from the adjusting force of the adjusting mechanism, which simplifies the control of the adjusting mechanism.

In a further embodiment of this invention, at least one safety element is provided, which works in concert with the blade element and provides a secure mounting in the appropriate mounting receptacle of the coating machine.

The adjusting unit may include, for example, at least one pivoting lever having a fulcrum arrangement. Specifically, the free end of the fulcrum arrangement acts upon the blade element, and the other free end of the fulcrum arrangement can be moved by a force-generating device having a force-generating arrangement. By applying the fulcrum arrangement, the force-generating arrangement must not be located in the immediate vicinity of the discharge nozzle, where typically not much space is available. Instead, such a force-generating arrangement can be placed in an area where space is more readily available.

A pressure hose arrangement can be used as a force-generating arrangement. Alternatively, one can also use pneumatic, hydraulic, hydro-pneumatic, electric, electrochemical, or any other applicable devices.

In yet a further embodiment, the force-generating arrangement includes a plurality of force-generating devices, allowing such forces to be distributed perpendicular to the surface. This makes it possible to adjust the height of the nozzle gap in several sections along the working width of the surface independently from one another, which allows a cross-profiling of the coating being applied onto the surface.

The pivot bearing of the fulcrum lever arrangement and/or the minimum of one force-generating device can each be mounted on a distribution pipe or a part connected to it.

An alternative adjusting methodology of the first embodiment allows the blade element to be placed in a mounting receptacle that can be adjusted by the adjusting mechanism. In this case, the mounting can be made of a joint element having cylinder segments. Specifically, the joint element is placed in a socket, which is connected to the distribution pipe or a part mounted to it. The adjusting mechanism can act upon the joint element on the side of the coating machine, for example, either on the drive side or on the guide side of the coating machine where there is sufficient room available.

In an even further embodiment of the coating of the present invention, it is also possible for the adjusting mechanism not to act upon the nozzle lip which includes the blade element but to act upon a second nozzle lip which has no blade element. A joint element, composed of cylinder segments, is part of the second nozzle lip and is movable in a socket via an adjusting mechanism, which, in turn, should be attached to the distribution pipe or a part mounted to it. Furthermore, the second nozzle lip can be an integrated element of the joint element or made as an individual piece connected to the joint element. For the latter, it is fluid-dynamically preferred for the joint element to be, in essence, tear-dropped shaped. Specifically, the area of the section which is supported by the socket has essentially the outline of a circle while the section forming the nozzle lips decreases to a sharp comer. Again, the adjusting mechanism can act upon at least one of the ends of the joint elements, either on the drive side or the guide side of the coating machine.

If both nozzle lips are part of the adjusting mechanism, the coating machine can, in accordance to the present invention, not only affect the nozzle height by a coordinated adjustment of the position of both nozzle lips but also the direction of the jet of the coating medium exiting the discharge nozzle, without having to change the position of the coating machine. This is especially advantageous because the optimum angle of the cooling medium jet with respect to the moving surface can be achieved by adjusting parts that have relatively low mass inertias and can accordingly be adjusted correspondingly fast.

The adjustment of the two nozzle lips can also be performed in a manner such that the nozzle lip formed by the blade element can be moved from an idle position to an operational position at which it shall remain during operation. For example, the blade element can be moved against a mechanical stop, as already mentioned above. The height adjustment of the nozzle gap during normal operation is accomplished by adjustment of the other nozzle lip. To “flush out” the nozzle gap, it is, however, possible to temporarily move the blade element from the operational position to the idle position. The widening in the nozzle height achieved through this procedure can, if so desired, be assisted by the pressure pulse generated by the widening of the nozzle gap.

In a further embodiment of this invention, the nozzle lips are formed of a minimum of two shell-like or shell shaped pieces, which together form the walling of a distribution channel located upstream of the discharge nozzle with respect to the flow of the coating medium. Such shell-like pieces are easier to manufacture using cast or extrusion manufacturing technologies rather than are profile pipes, which, in turn, also benefits the manufacturing process of the coating machine of the present invention. The two shell-like pieces can also be manufactured of fiber-reinforced plastic, i.e., carbon fiber-reinforced plastic (CFRP), or Polyvinylchloride, (PVC), especially, chlorinated Polyvinylchloride (PVC-C). They can be connected to one another simply through adhesion, bolting, or a similar method.

Additionally, the shell-like pieces can form together an equalization chamber that resides between the distribution channel and the discharge nozzle, in which the coating medium exiting the distribution channel is equalized prior to entering the nozzle gap. Attached to the shell-like pieces, receptacles or mounting arrangements can be incorporated for each respective nozzle lip.

Finally, in a further embodiment of this invention, the coating machine includes a distribution channel located upstream of the discharge nozzle with respect to the coating medium flow; an equalization chamber that resides between the distribution channel and the discharge nozzle; and a device for accommodating an insert in the transitional section between the distribution channel and the equalization chamber, the device having a plurality of openings for the coating medium exiting the distribution pipe. This insert can, in accordance to this invention, be a “blending device” between the distribution channel and the equalization chamber and is designed so as to be interchangeable with an insert having a smaller or larger number of openings and/or openings with smaller or larger cross-sectional areas, in order to accommodate a variety of coating mediums with a range of viscosities.

A simplification of the coating machine construction and its components can be achieved by making the distribution pipe a separate entity from the associated carrier element or beam. This modular construction allows a relatively simple, thermally isolated attachment of the distribution pipe onto the carrier element. This avoids stresses associated with the entire apparatus, especially stresses in the distribution pipe, as a result of expansion differences between the carrier element and the distribution pipe. Different thermal expansion coefficients associated with the materials that are used for the different parts will therefore not have a negative impact on the coating quality.

Although the above embodiments are based on a free-jet coating machine that is positioned at a distance from the moving surface and is configured for applying coating medium onto the moving surface under high pressure using a free unsupported jet, the coating machine, as designed per this invention, can also be applied as a curtain coater, i.e., a coating machine with short dwell time (SDTA—short dwell time applicator). In the latter, the nozzle gap, delimited by the nozzle lips, forms the applicator chamber, in which the coating medium is brought into contact with the moving surface during a short residence time. With this design, the downstream nozzle lip can be designed to serve the function of applying the final metering and, if desired, of equalizing the coating medium being applied onto the surface. Alternatively, such a final metering/equalization function can be accomplished by a device that is mounted separately.

With curtain coaters, the coating medium is applied by taking advantage of gravity. This limits the amount of application so that final metering/equalization is no longer required.

### BRIEF DESCRIPTION OF THE DRAWINGS

The invention is explained in more detail using several embodiments that are being by described by drawings which are included. The following applies:

FIGS. 1-6 are schematic cross-sectional views of various embodiments of coating machines of the present invention.

Corresponding reference characters indicate corresponding parts throughout the several views. The exemplifications set out herein illustrate at least one preferred embodiment of the invention, in one form, and such exemplifications are not to be construed as limiting the scope of the invention in any manner.

### DETAILED DESCRIPTION OF THE INVENTION

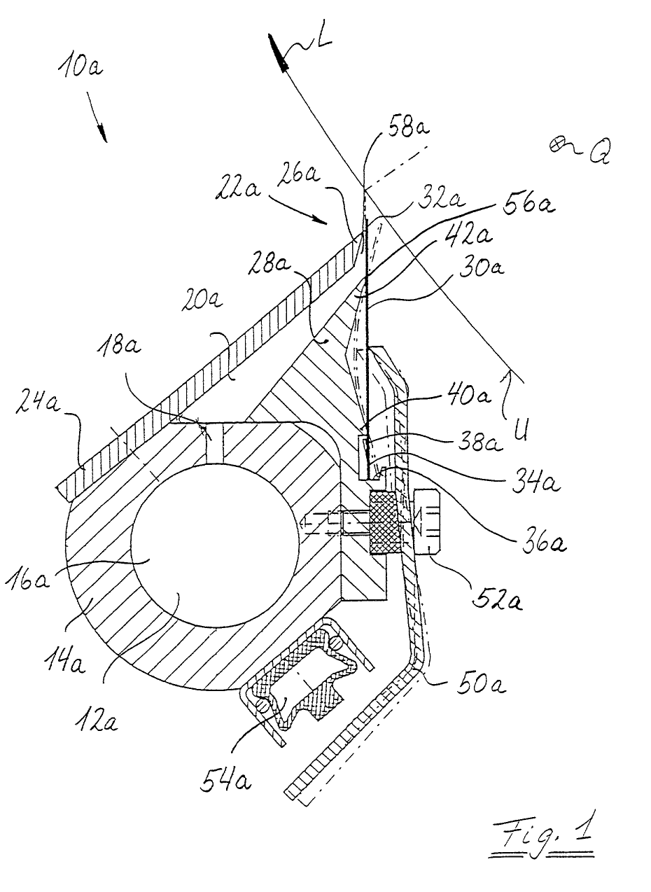

In FIG. 1, the coating machine of the present invention is generally labeled 10a. It serves to apply a liquid or viscid coating medium 12a onto a moving surface U which traverses in a direction indicated by arrow L. Surface U can be the outer surface of a material web, i.e., a web made of paper or cardboard (direct application) or the outer surface of a transfer roll which transfers coating medium 12a onto the material web at a different location (indirect application).

Coating machine 10a includes distribution pipe 14a, which has an interior cavity 16a, positioned perpendicular to surface U. It is into interior cavity 16a where coating medium 12a is supplied. Distribution pipe 14a has a plurality of through-holes 18a formed in a transverse direction Q, through which coating medium 12a flows into equalization chamber 20a, which, in essence, extends across the entire working width of surface U and serves to equalize the flow of coating medium 12a exiting through-holes 18a. Coating medium 12a flows through equalization chamber 20a into discharge nozzle 22a from which it subsequently exits coating machine 10a in form of a jet, which impacts surface U.

Equalization chamber 20a is delimited by an essentially solid, flat element 24a, which is mounted on distribution pipe 14a, and onto whose downstream end forms nozzle lip 26a. Equalization chamber 20a is also delimited by adapter piece 28a, which is also mounted onto distribution pipe 14a and which further serves the purpose of retaining blade element 30a. The free end of blade element 30a forms the feed-side edge of nozzle lip 32a of discharge nozzle 22a. The mounting of equalization chamber delimiting parts 24a and 28a is best accomplished by a bolted connection. This approach is especially advantageous for part 24a as it facilitates easy replacement of trailing nozzle lip 26a for maintenance reasons.

Blade element 30a is attached by end 34a thereof which is opposite of nozzle lip end 32a, in mounting cavity 36a of second equalization chamber element 28a. Protruding tab 38a of blade element 30a engages into shoulder 40a of equalization chamber-delimiting element 28a and keeps blade element 30a from moving out of mounting receptacle 36a towards the top of FIG. 1. Additionally, blade element 30a is in contact with section 42a of second distribution chamber delimiting element 28a.

Further, lever 50a is provided which is mounted on lever bearing 52a in such a manner so as to allow it to pivot. Lever 50a is mounted to second equalization chamber-delimiting element 28a. Per FIG. 1, adjusting mechanism 54a acts upon the free end of lever 50a (FIG. 1 shows a pressure hose arrangement), through which lever 50a can be pivoted around lever bearing 52a. The upper end of lever 50a is in contact with blade element 30a in a location between mounting cavity 36a and support location 56a of blade element 30a at support section 42a of second distribution chamber delimiting element 28a. When activating adjusting mechanism 54a, lever 50a is moved to the position indicated by the dash-dot-dash line which causes it to bend, resulting in a widening of nozzle gap 58a formed by nozzle lips 26a and 32a. If the adjusting force of adjusting mechanism 54a is reduced, i.e., by lowering the gas pressure of the pressure hose, lever 50a is moved back with the help of its elastic properties to its original position, as indicated in FIG. 1 by the solid lines. This allows an adjustment of nozzle gap 58a by balancing the adjusting force of adjusting mechanism 54a and the spring force of blade element 30a.

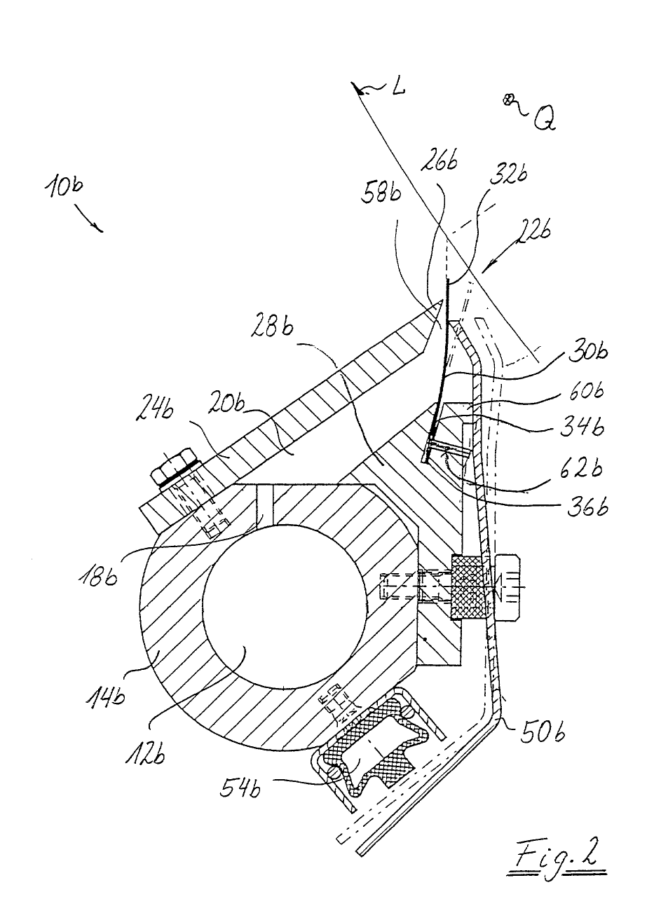

FIG. 2 illustrates a second embodiment of a coating machine and essentially corresponds to the one shown in FIG. 1. The same parts use the same reference numbers but are accompanied by the lower case letter “b” instead of the lower case letter “a”. Furthermore, the embodiment shown in FIG. 2 is only described to the extent that it differs from the embodiment shown in FIG. 1, whose description expressly applies unless otherwise indicated.

Coating machine 10b, shown in FIG. 2, differs from coating machine 10a mainly by the fact that blade element 30b deforms in a manner causing a reduction in nozzle gap height 58b when activating lever 50b by activation mechanism 54b, i.e., by increasing the gas pressure of the pressure hose. This is achieved by blade element 30b being in contact solely via end 34b thereof in receptacle 36b with second equalization chamber-delimiting element 28b with no other support being utilized. The respective height of nozzle gap 58b is the result of the balance between the force generated by adjusting mechanism 54b and the spring force of deformed blade element 30b.

The embodiment shown in FIG. 2 further features mechanical stop 60b for lever 50b on second equalization chamber-delimiting element 28b which determines the maximum deflection of blade element 30b and, thus, the minimum height of nozzle gap 58b. Finally, the embodiment shown in FIG. 2 also features safety dowel 62b which is mounted in second equalization chamber-delimiting element 28b in such a manner as to cause it to be engaged with blade element 30 by lever 50b and thus securing it in receptacle 36b.

The detailed description of FIG. 1 still applies with respect to the supply of coating medium 12b through distribution pipe 14b, the passage of coating medium 12b through openings 18b in equalization chamber 20b being delimited by first equalization chamber-delimiting element 24b, the design of discharge nozzle 22b with nozzle lips 26b and 32b, etc.

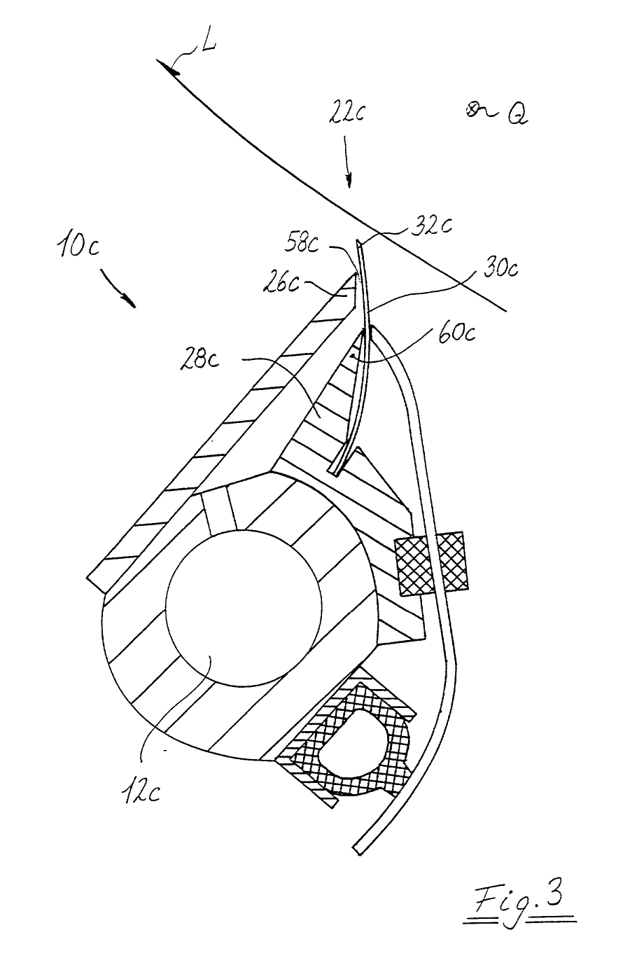

FIG. 3 illustrates an additional embodiment of a coating machine 10c, and essentially relates to the discussions of the previous embodiments. FIG. 3 uses for the same parts the same reference numbers as FIG. 1 but are accompanied by the lower case letter “c” instead of the lower case letter “a.” Furthermore, the embodiment shown in FIG. 3 is only described to the extent that it differs from the embodiments shown previously whose description expressly applies unless otherwise indicated.

Coating machine 10c, depicted in FIG. 3, illustrates that mechanical stop 60c of second equalization chamber-delimiting element 28c, which limits the minimum opening height of nozzle gap 58c, can also serve as a mechanical stop for blade element 30c, which is different compared to the design shown in FIG. 2, which uses mechanical stop 60b for lever 50b. Otherwise, coating machine 10c, as shown in FIG. 3, corresponds in construction and functionality to coating machine 10b of FIG. 2, especially, as far as using discharge nozzle 20c and its nozzle lips 26c and 32c to facilitate the discharging of coating medium 12c is concerned.

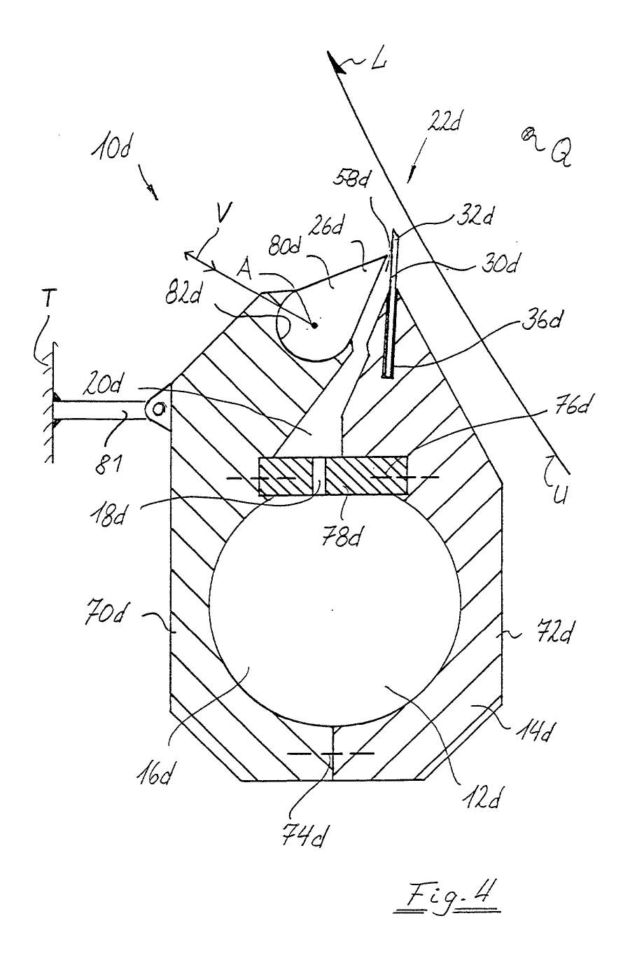

FIG. 4 illustrates an additional embodiment of a coating machine of the present invention, which essentially relates to the discussions of the previous embodiments. FIG. 4 uses for the same parts the same reference numbers as FIG. 1 but are accompanied by the lower case letter “d” instead of the lower case letter “a”. Furthermore, the embodiment shown in FIG. 4 is only described to the extent that it differs from the embodiments shown previously whose description expressly applies unless otherwise indicated.

In coating machine 10d according to FIG. 4, coating medium 12d is supplied to distribution channel 16d of distribution pipe 14d, which is formed by two shell-like pieces 70d and 72d. In the embodiment shown, shell-like pieces 70d and 72d are connected to one another at location 74d and 76d by a bolted connection. Bolted connection 76d also incorporates insert 78d in which through-holes 18d are formed for the purpose of allowing coating medium 12d to flow into equalization chamber 20d. Equalization chamber 20d is also formed by shell-like pieces 70d and 72.

The upper end of shell-like piece 72d contains mounting cavity 36d into which blade element 30d is positioned and whose free end forms feed-side nozzle lip 32d of nozzle gap 58d of discharge nozzle 22d located adjacent to equalization chamber 20d. Trailing nozzle lip 26d is formed by a joint element 80d. Joint element 80d is essentially tear drop-shaped in its cross-section and is mounted in socket 82d formed in first shell-like piece 70d in a manner allowing it to be pivoted around its axis A. In order to adjust to the desired pivot position of joint element 80d, adjusting mechanism V (a lever arrangement, for example) is provided (shown schematically) and engages on at least one of the two ends of joint element 80d, specifically on the guide side and/or on the drive side of coating machine 10d.

FIG. 4 also depicts mounting arms 81 which serve to support the coating machine on a carrier element T, i.e., a coater beam, and whose depiction also applies to the other embodiments of the present invention. The mounting arms are distributed at a distance of approximately 1,200 mm from one another across the entire machine width, and are attached in an articulated fashion to distribution pipe 14a-c (FIGS. 1 through 3) or shell-like piece 70d and 72d (FIG. 4 and beyond). This provides a simple and cost-effective thermal isolation of distribution pipe 14a-c from carrier element T.

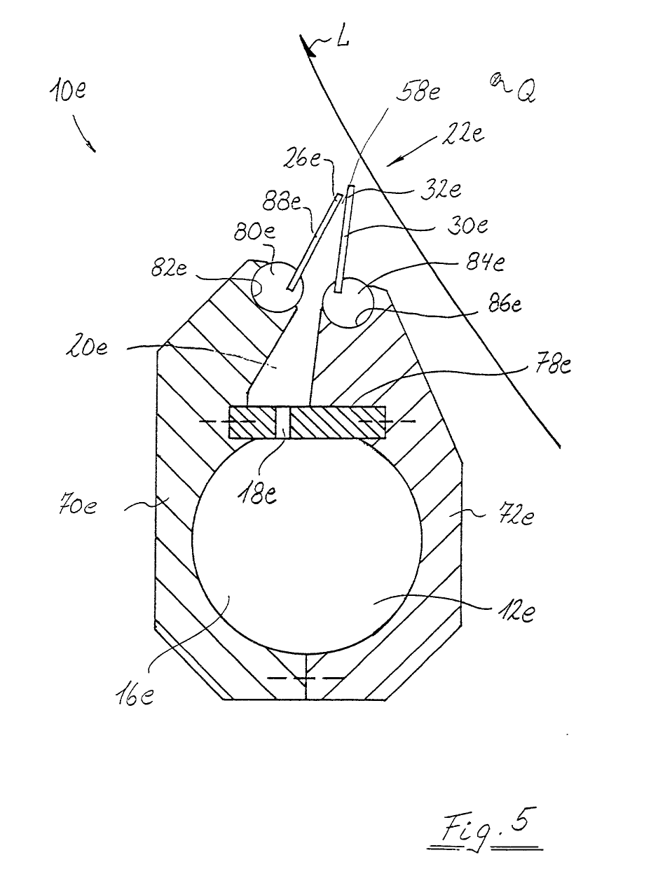

FIG. 5 depicts an additional embodiment of a coating machine of the present invention and essentially relates to the discussions of the previous embodiments. FIG. 5 uses for the same parts the same reference numbers as FIG. 1 but are accompanied by the lower case letter “e” instead of the lower case letter “a”. Furthermore, the embodiment shown in FIG. 5 is only described to the extent that it differs from the embodiments shown previously whose description expressly applies unless otherwise indicated.

Coating machine 10e shown in FIG. 5, differs from coating machine 10d shown in FIG. 4 mainly by the fact that joint element 80e, mounted in joint socket 82e of first shell-like piece 70e in a manner allowing it to pivot, is not limited only to trailing nozzle lip 26e but is also applied to feed-side nozzle lip 32e, which also includes joint element 84e mounted in joint socket 86e of second shell-like piece 72e in a manner allowing it to pivot. This allows not only nozzle height 58e of discharge nozzle 22e to be varied but also the direction of coating medium 12e leaving discharge nozzle 22e. Furthermore, both nozzle lips 26e and 32e are extensions of blade elements 30e and 88e, respectively, which are mounted in joint elements 80e and 84e. With respect to the delimitation of distribution channel 16e and equalization chamber 20e by shell-like pieces 70e and 72e, as well as with respect to insert 78e with through-holes 18e, reference is made to the description of the embodiment of FIG. 4.

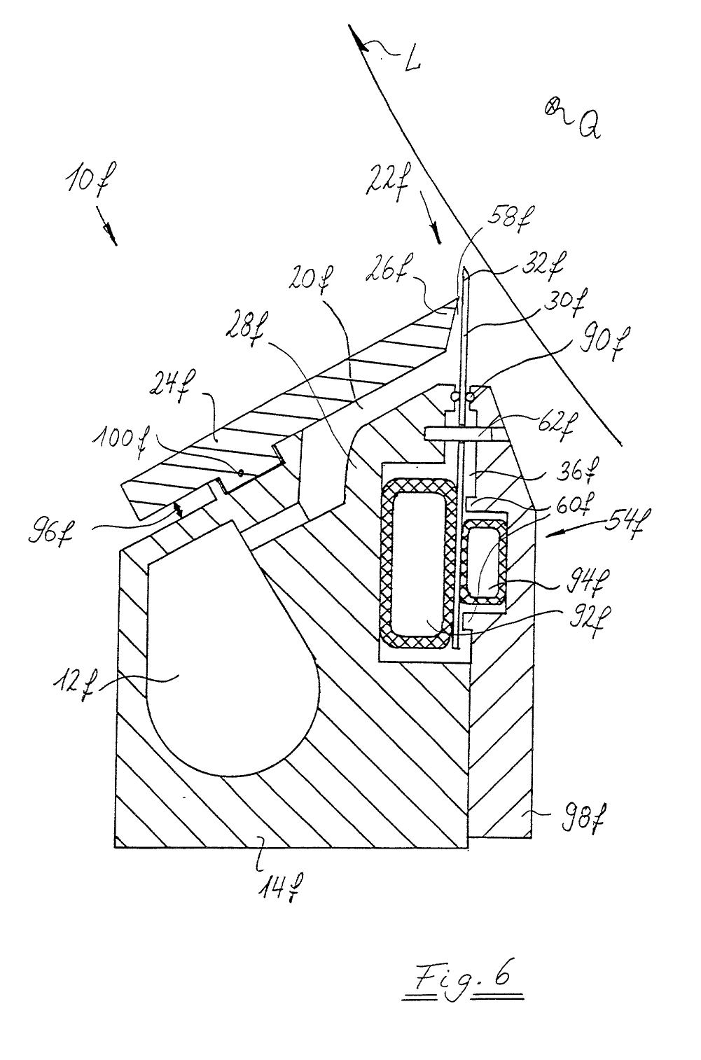

FIG. 6 depicts an additional embodiment of a coating machine of the present invention and essentially relates to the discussions of the previous embodiments. FIG. 6 uses for the same parts the same reference numbers as FIG. 1 but are accompanied by the lower case letter “f” instead of the lower case letter “a”. Furthermore, the embodiment shown in FIG. 6 is only described to the extent that it differs from the embodiments shown previously whose description expressly applies unless otherwise indicated.

Similar to the embodiment of FIG. 5, coating machine 10f, as shown in FIG. 6, is also equipped with adjustable nozzle lip 32f on blade element 30f, as well as nozzle lip 26f formed by delimiting element 24f for first equalization chamber 20f.

Blade element 30f, which is secured by safety dowel 62f in mounting cavity 36f, is mounted on pivot bearing 90f formed of two round cords. One of the round cords resides in a cavity in second equalization chamber-delimiting element 28f which is formed as a single piece item together with distribution pipe 14f, while the second round cord resides in a cavity in cover element 98f. Adjusting mechanism 54f for blade element 30f includes two pressure hose arrangements 92f and 94f, which act upon blade element 30f in opposite directions. Pressure hose arrangement 92f forces blade element 3 Of against mechanical stop 60f during operation of coating machine 10f.

Adjusting mechanism 96f (schematically shown by a double arrow) for first equalization chamber-delimiting element 24f, which includes nozzle lip 26f, is mounted on distribution pipe 14f at location 100f in a manner allowing it to be pivoted.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A coating machine for applying a liquid or viscid coating medium onto a moving surface, the moving surface being an outer surface of one of a material web and a transfer element, the material web being one of a paper web and a cardboard web, the moving surface being the outer surface of a material web in the case of direct application, the moving surface being the outer surface of a transfer element in the case of indirect application, the moving surface having a feed direction, said coating machine comprising:
a discharge nozzle configured for discharging the coating medium onto the moving surface, a feed side of said discharge nozzle being a side of said discharge nozzle facing a portion of the moving surface located upstream of said discharge nozzle relative to the feed direction, a trailing side of said discharge nozzle being a side of said discharge nozzle facing a portion of the moving surface located downstream of said discharge nozzle relative to the feed direction, said discharge nozzle including a first nozzle lip and a second nozzle lip, said first nozzle lip residing on said feed side of said discharge nozzle, said second nozzle lip residing on said trailing side of said discharge nozzle, at least one of said first nozzle lip and said second nozzle lip comprising a blade element.

2. The coating machine of claim 1, wherein the transfer element is a transfer roll configured for transferring the coating medium onto the material web.

3. The coating machine of claim 1, wherein said first nozzle lip and said second nozzle lip define a nozzle gap therebetween, a distance between said first nozzle lip and said second nozzle defining a nozzle gap height, said coating machine further comprising an adjustment mechanism operatively connected with said discharge nozzle, said adjustment mechanism being configured to adjust the nozzle gap height.

4. The coating machine of claim 3, wherein said adjustment mechanism is operatively connected to said blade.

5. The coating machine of claim 4, wherein said adjustment mechanism is capable of one of bending and pivoting said blade element.

6. The coating machine of claim 4, wherein said blade element has an initial base position, said initial base position of said blade element being unaffected by said adjusting mechanism, an increasing activation of said adjusting mechanism increasing said nozzle gap height, starting from said initial base position of said blade element.

7. The coating machine of claim 4, wherein said blade element has two length-wise edges, said blade element being mounted to said coating machine with one of said length-wise edges, said length-wise edge to which said blade element is mounted thereby defining a mounting edge, said blade element being supported by said coating machine at a support position, said support position being located between said two length-wise edges, said adjusting mechanism being configured to act upon said blade element at a position between said support position and said mounting edge extending in a length-wise direction.

8. The coating machine of claim 4, wherein said blade element has an initial base position, said initial base position of said blade element being unaffected by said adjusting mechanism, an increasing activation of said adjusting mechanism decreasing said nozzle gap height, starting from said initial base position of said blade element.

9. The coating machine of claim 1, wherein said coating mechanism further includes a pivot bearing located proximate said blade element, said blade element being mounted in said pivot bearing.

10. The coating machine of claim 4, wherein said adjustment mechanism comprises a first partial adjustment mechanism and a second partial adjustment mechanism, said first partial adjustment mechanism and said second partial adjustment mechanism being configured to act upon said blade element in opposite directions relative to each other.

11. The coating machine of claim 5, further comprising a mechanical stop, said mechanical stop being configured for defining a maximum one of a deflection and a pivot movement of said blade element.

12. The coating machine of claim 1, further comprising both a mounting receptacle in which said blade element is mounted and a safety element which interacts with said blade element and thereby secures said blade element in said mounting receptacle.

13. The coating machine of claim 5, wherein said adjustment mechanism has a pivot unit for pivoting said blade element, said pivot unit comprising at least one pivoting lever, each pivoting lever including a fulcrum arrangement, said fulcrum arrangement of each pivoting lever having a first free end and a second free end, said first free end coacting with said blade element, said fulcrum arrangement having at least one force-generating device associated therewith, said at least one force-generating device associated therewith being capable of moving said second free end thereof, each force-generating device including a force-generating arrangement.

14. The coating machine of claim 13, further including a distribution pipe for distributing the coating medium and a pivot bearing, said blade element being mounted in said pivot bearing, said pivot bearing being attached to one of said distribution pipe and a part which is connected to said distribution pipe.

15. The coating machine of claim 13, further including a distribution pipe for distributing the coating medium, said at least one force-generating device associated with said fulcrum arrangement being attached to one of said distribution pipe and a part which is connected to said distribution pipe.

16. The coating machine of claim 4, further comprising a first mounting arrangement, said blade element being mounted in said first mounting arrangement, said adjusting mechanism being configured for positionally adjusting said first mounting arrangement.

17. The coating machine of claim 16, wherein said first mounting arrangement comprises a cylinder segment-shaped joint element.

18. The coating machine of claim 17, further including a distribution pipe for distributing the coating medium, said first mounting arrangement further including a first joint socket, said first joint socket being a part of one of said distribution pipe and a member connected to said distribution pipe, said cylinder segment-shaped joint element being seated in said first joint socket.

19. The coating machine of claim 3, wherein one of said first nozzle lip and said second nozzle lip comprises a blade element, an other of said first nozzle lip and said second nozzle lip lacking a blade element, said adjustment mechanism not configured for affecting said one of said first nozzle lip and said second nozzle lip which comprises a blade element, said adjustment mechanism configured for affecting said other of said first nozzle lip and said second nozzle lip.

20. The coating machine of claim 18, further comprising a second mounting arrangement including a second joint socket, and wherein one of said first nozzle lip and said second nozzle lip comprises a blade element, an other of said first nozzle lip and said second nozzle lip comprising a cylinder segment-shaped joint element, said other of said first nozzle lip and said second nozzle lip being mounted in said second joint socket and capable of being moved by said adjustment mechanism.

21. The coating machine of claim 20, wherein said second joint socket is a part of one of said distribution pipe and a member connected to said distribution pipe.

22. The coating machine of claim 19, further comprising a joint element, said other of said first nozzle lip and said second nozzle lip comprises a lip element, said joint element holding said lip element.

23. The coating machine of claim 19, further comprising a joint element, said other of said first nozzle lip and said second nozzle lip comprises a lip element, said joint element and said lip element being integrally formed.

24. The coating machine of claim 19, further comprising a joint element, said other of said first nozzle lip and said second nozzle lip comprising a lip element, said joint element one of holding and being integrally formed with said lip element, said joint element having an essentially tear-shaped cross-section.

25. The coating machine of claim 17, wherein said joint element has a plurality of ends, said adjustment mechanism being configured for acting upon at least one of said ends of said joint element.

26. The coating machine of claim 19, further comprising a joint element, said other of said first nozzle lip and said second nozzle lip comprising a lip element, said joint element one of holding and being integrally formed with said lip element, said joint element having a plurality of ends, said adjustment mechanism being configured for acting upon at least one of said ends of said joint element.

27. The coating machine of claim 3, wherein said coating machine has at least one said adjustment mechanism, each nozzle lip having an adjusting mechanism associated therewith.

28. A coating machine for applying a liquid or viscid coating medium onto a moving surface, the moving surface being an outer surface of one of a material web and a transfer element, the material web being one of a paper web and a cardboard web, the moving surface being the outer surface of a material web in the case of direct application, the moving surface being the outer surface of a transfer element in the case of indirect application, the moving surface having a feed direction, said coating machine comprising:
a supply of the coating medium, said supply configured for establishing a supply flow of the coating medium and a corresponding supply flow direction thereof;
at least two shell-shaped pieces, said shell-shaped pieces together forming delimiting walls of a distribution channel, said distribution channel receiving said supply flow; and
a discharge nozzle positioned downstream relative to said supply flow direction from and in fluid communication with said distribution channel, said discharge nozzle being configured for discharging the coating medium onto the moving surface.

29. The coating machine of claim 28, wherein said shell-shaped pieces together further form an equalization chamber, said equalization chamber being located between said distribution channel and said discharge nozzle.

30. A coating machine for applying a liquid or viscid coating medium onto a moving surface, the moving surface being an outer surface of one of a material web and a transfer element, the material web being one of a paper web and a cardboard web, the moving surface being the outer surface of a material web in the case of direct application, the moving surface being the outer surface of a transfer element in the case of indirect application, the moving surface having a feed direction, said coating machine comprising:
a supply of the coating medium, said supply configured for establishing a supply flow of the coating medium and a corresponding supply flow direction thereof;
a discharge nozzle configured for receiving the supply flow of the coating medium and for discharging the coating medium onto the moving surface;
at least one distribution channel wall, said at least one distribution channel wall collectively forming a distribution channel, said distribution channel being located in fluid communication with and upstream of said discharge nozzle with respect to the supply flow direction;
at least one equalization chamber wall, said at least one equalization chamber wall collectively forming an equalization chamber; said equalization chamber being located between said distribution channel and said discharge nozzle, a transitional section being located between said distribution channel and said equalization chamber; and
an insert positioned in said transitional section, said insert having a plurality of through-holes therein, said through-holes being structured and arranged to establish fluid communication between said distribution channel and said equalization chamber wall and thereby permit the coating medium to flow from said distribution channel to said equalization chamber.

31. The coating machine of claim 1, further comprising a distribution pipe and an associated carrier element, said distribution pipe configured for distributing the coating medium toward said discharge nozzle, said distribution pipe being carried by but separate from said distribution pipe.

32. The coating machine of claim 31, wherein said distribution pipe is mounted so as to be thermally isolated from said associated carrier element.
